(19) United States
(12) Patent Application Publication
(10) Pub. No.: US 2013/0189590 A1
(43) Pub. Date: Jul. 25, 2013

(54) INORGANIC ELECTROLYTE MEMBRANE FOR ELECTROCHEMICAL DEVICES, AND ELECTROCHEMICAL DEVICES INCLUDING SAME

(71) Applicants: Zanotti Jean-Marc, Chatenay-Malabry (FR); Lagrene Karine, Paris (FR)

(72) Inventors: Zanotti Jean-Marc, Chatenay-Malabry (FR); Lagrene Karine, Paris (FR)

(73) Assignee: COMMISSARIAT A L'ENERGIE ATOMIQUE ET AUX ENERGIES ALTERNATIVES, Paris (FR)

(21) Appl. No.: 13/811,946

(22) PCT Filed: Jul. 22, 2011
(86) PCT No.: PCT/EP2011/062669

§ 371 Date: Apr. 5, 2013

(30) Foreign Application Priority Data
Jul. 27, 2010 (FR) 10 56178

(51) Int. Cl. H01M 10/056; H01M 10/052

(52) U.S. Cl. CPC H01M 10/056; H01M 10/052
USPC 429/312; 429/304; 429/320; 429/306; 429/323; 429/322

(57) ABSTRACT

A mineral electrolyte membrane wherein:
the membrane is a porous membrane made of an electrically insulating metal or metalloid oxide comprising a first main surface (1) and a second main surface (2) separated by a thickness (3);
through pores or channels (4) open at their both ends (5,6), having a width of 100 nm or less, oriented in the direction of the thickness (3) of the membrane and all substantially parallel over the entire thickness (3) of the membrane, connect the first main surface (1) and the second main surface (2); and
an electrolyte, in particular a polymer electrolyte is confined in the pores (4) of the membrane.

An electrochemical device, in particular a lithium-metal or lithium-ion storage battery comprising said membrane.

### TECHNICAL FIELD

The invention concerns a mineral electrolyte membrane for electrochemical devices.

The invention particularly concerns a mineral membrane with a polymer electrolyte for electrochemical devices.

The invention further concerns an electrochemical device comprising this mineral electrolyte membrane, in particular with a solid polymer electrolyte.

In particular, the invention concerns a lithium storage battery, accumulator, in particular a lithium-metal or lithium-ion storage battery, accumulator, comprising said mineral electrolyte membrane.

The technical field of the invention may generally be defined as the field of electrochemical devices, in particular of lithium storage batteries and more specifically lithium-metal storage batteries and/or lithium-ion storage batteries comprising an electrolyte.

### STATE OF THE PRIOR ART

The electrolytes of lithium-metal or lithium-ion storage batteries, accumulators consist generally of lithium salts dissolved in a polymer matrix, hence the name <<polymer electrolyte>> or <<electrolyte polymer>>.

The usual polymers of these polymer electrolytes are semi-crystalline polymers in which amorphous and crystalline phases co-exist.

Therefore, the polymer matrix of lithium-metal storage batteries consist generally of polyethylene oxide polymers (PEOs) meeting the formula [CH₂—CH₂—O]ₙ where the value of n is about 3000 for example.

POE is a semi-crystalline polymer and the melting point of pure POE is about 55° C.

It is known that ionic conduction and in particular that of Li⁺ ions preferably occurs in the amorphous phase.

The adding of a lithium salt, to a certain extent, already causes amorphization of semi-crystalline polymers such as PEO, which promotes ionic conduction; this remains insufficient however to ensure levels of ionic conductivity equivalent to that of liquids or polymers in the molten state.

In addition, in polymer electrolytes, it is shown that ionic conductivity is closely related to the dynamics of the polymer chains, these dynamics being faster the higher the temperature.

The conjunction of the two phenomena described in the foregoing (namely the fact that the ionic conductivity of a polymer electrolyte is promoted by an increased amorphous fraction of a polymer such as PEO, and the fact that the ionic conductivity of a polymer electrolyte increases with temperature) means that the ionic conductivity of the POE/Li system is much too low to envisage applications at ambient temperature, in particular in power units.

On the other hand, on and after 60° C. to 80° C., the ionic conductivity of this system may reach 10⁻³ S.cm⁻¹, which is technically viable.

For applications in the automotive industry for example, the storage battery must be maintained in the region of 80° C.

This constraint is most unfavourable from the viewpoint of global energy yield, limits the field of use of storage batteries comprising such polymer electrolytes to heavy equipment such as motor vehicles, and prohibits any application in the field of consumer electronics and in particular for computers, MP3 players and all lightweight, portable electronic equipment.

On this account, to increase the ionic conductivity at ambient temperature of polymer electrolytes with semi-crystalline polymers, such as POEs, it is sought to further increase the proportion of amorphous phase in these polymers.

Several methods such as the incorporation of plasticizers into the polymer, the use of block copolymers derived from POE or the adding to the polymer of mineral fillers of nanometric size such as ceramic nanoparticles can be used to increase the fraction of amorphous phase and thereby increase ionic conductivity.

However, all these methods which are intended to increase the amorphous fraction of semi-crystalline polymers only allow conductivity to be reached which still remains too low.

Document US-B2-7,641,997 concerns an ionic conductive membrane which comprises a matrix comprising an ordered array of hollow channels and a nanocrystalline electrolyte contained in these channels.

The channels have open ends and they have a width of 1000 nanometres or less, preferably 60 nanometres or less, more preferably 10 nanometres or less. The channels can be aligned perpendicular to the surface of the matrix and the length of the channels may range from 100 nanometres to 1000 micrometres.

The electrolyte has a grain size of 100 nm or less, preferably of 1 to 50 nm.

The matrix may made of an oxide such as silica or aluminium oxide, or else of silicon.

The nanocrystalline electrolyte may be an electrolyte which conducts oxygen ions and which comprises an oxide and a metal dopant such as metal-doped zirconia or else the electrolyte conducts protons and comprises a metal-doped ceria. In one embodiment, the matrix is made of silica, and the electrolyte is an electrolyte which conducts oxygen ions and consists of yttria- or yttrium-doped zirconia (YSZ).

In this document, although it is indicated that the ionic conductivity of the membrane is improved, there is never any mention of the conduction of alkaline ions such as lithium ions. In addition, the nanocrystalline electrolyte in this document is not a polymer electrolyte since it consists solely of mineral nanoparticles such as YSZ particles which are not trapped in an organic polymer, in particular in a semi-crystalline polymer such as POE.

Finally, the field of application of the ionic conducting membranes of this document does not concern storage batteries and in particular lithium storage batteries. Having regard to their structure, these membranes would not be suitable for use in these batteries.

The document by F. Vullum and D. Teeters <<Investigation of lithium battery nanoelectrode arrays and their component nanobatteries>>, Journal of Power Sources 146, (2005), 804-808, describes the manufacture of a battery consisting of an assembly of lithium <<nano-batteries>>.

By using alumina membranes having pores of a diameter of 200 nm, a diameter of 13 mm and a thickness of 60 μm (these being Whatman Anodisc® filtering membranes), the pores of the membrane are filled to about one third with an electrolyte consisting of POE complexed with lithium triflate to an oxygen/lithium ratio of 15:1, and the remainder of the volume of the pores is filled with an <<ambigel>> of V₂O₅ forming the cathode.

In this document, it is essentially sought to prepare a nano-battery and not a membrane with a solid polymer electrolyte.

The size of the pores does not lie within a nanometric range to ensure nanoconfinement.

The main purpose of this document is to reduce the size of batteries and not to improve the ionic conductivity of polymer electrolytes. In this document, it is rather more sought to achieve amorphization of the polymer and not the lowering of its melting point by confinement.

In the light of the foregoing there is therefore a need for an electrolyte, in particular a polymer electrolyte, intended in particular for use in a lithium storage battery, accumulator, such as a lithium-metal or lithium-ion storage battery, accumulator with which it is possible to improve the performance of existing polymer electrolytes.

In particular, there is a need for an electrolyte, in particular a polymer electrolyte, which has good ionic conductivity at ambient temperature, for example able to reach a value of 10⁻³ S/cm.

It is the goal of the present invention to provide an electrolyte, and in particular a polymer electrolyte, which meets these needs inter alia.

A further goal of the invention is to provide an electrolyte, in particular a polymer electrolyte which does not have the shortcomings, defects, limitations and disadvantages of prior art electrolytes and which solves the problems of electrolytes and in particular of polymer electrolytes of the prior art, notably with regard to performance and in particular with regard to insufficient ionic conductivity at ambient temperature.

### DESCRIPTION OF THE INVENTION

This goal, and others, is reached according to the invention by means of a mineral electrolyte membrane (a mineral membrane with an electrolyte) in which:
the membrane is a porous membrane made of an electrically insulating metal or metalloid oxide comprising a first main surface and a second main surface separated by a thickness;
through pores or channels open at their both ends, of width 1000 nm or less, preferably 100 nm or less, oriented in the direction of the thickness of the membrane and all substantially parallel over the entire thickness of the membrane, connect the first main surface with the second main surface; and
an electrolyte is confined within the pores of the membrane.

The said electrolyte may be an electrolyte which comprises at least one compound comprising a fraction that is crystalline at any temperature below 100° C., and in particular at ambient temperature, before it is confined within the pores of the membrane. In this case the gain in performance of the device, such as a storage battery, accumulator, comprising the membrane of the invention, is obtained by reducing the melting point of the electrolyte under the effect of nanometric confinement, and hence by increasing the transport properties (diffusion coefficient of the electrolytes).

Or else, said electrolyte may be an electrolyte comprising at least one compound that is liquid or amorphous below 100° C., in particular at ambient temperature, before it is confined within the pores of the membrane and which remains liquid or amorphous when it is confined within the pores of the membrane.

In this case the gain in performance of the device, such as a storage battery comprising the membrane according to the invention, is obtained by 1D conduction. In this case too, the stress of mechanical strength of the electrolyte (its viscosity) is transferred to the confinement membrane.

In general, the electrolyte consists of said at least one compound comprising a crystalline or amorphous or liquid fraction, and optionally of at least one conductive salt.

By ambient temperature is generally meant a temperature of 15° C. to 30° C. e.g. from 20° C. to 25° C.

By substantially parallel in the meaning of the invention is meant that these channels have an orientation mosaicity which does not exceed 10%.

Preferably said channels are parallel.

By crystalline fraction is generally meant that this compound comprises an ordered phase with long-range order as compared to an amorphous phase which is a phase without any long-range order.

Advantageously, said crystalline fraction represents at least 1% by mass, preferably at least 10% by mass of the at least one compound, more preferably at least 20% by mass, further preferably at least 30% by mass of the at least one compound and advantageously up to 50%, 80%, 90% and even up to 100% by mass of the at least one compound.

Advantageously, the first and second main surfaces are planar and parallel, the membrane is a planar membrane and the pores or channels are substantially aligned, or aligned, perpendicular to said surface.

As already specified above, the pores are through pores at their both ends respectively located at the first and second main surfaces.

The pores or channels are all substantially parallel or parallel over the entire thickness of the membrane. The pores or channels do not communicate in the inside of the membrane. The pores or channels are in no way connected inside the membrane. Each of the pores or channels is separate, distinct, isolated from the other channels between the first main surface and the second main surface.

Each of the pores or channels is fully independent of the other pores or channels.

On this account, none of the channels or pores have any chicane, elbow, junction, branch-point, tortuosity or any kind of <<labyrinth>> able to prevent pure 1D transport.

In addition, the inner walls of the pores or channels are generally rectilinear, smooth, clean-cut, without any spikes, bumps, projections and do not have any surface able to block the transport of the electrolyte which would once again prevent pure 1D transport.

Advantageously, the pores or channels have a width of 10 nm to 1000 nm, preferably 10 nm to 100 nm, more preferably 20 nm to 50 nm, better still 30 nm to 40 nm.

Advantageously, the pores or channels are cylindrical pores.

Advantageously, said cylindrical pores have a circular or substantially circular cross-section, or an elliptical cross-section.

By substantially circular is generally meant that the shape of the cross-section, whilst globally preserving the shape of a circle, may have irregularities, imperfections.

The width of the pores or channels corresponds to the largest dimension of the cross-section of the pores or channels, this corresponding to the diameter for pores or channels of circular shape and to the major axis for pores or channels of elliptical shape.

Advantageously, the pores or channels have a length of 100 nm to 900 μm, preferably 1 μm to 800 μm, more preferably 1 μm to 500 μm, most preferably 100 μm to 300 μm.

Advantageously, the channels or pores are arranged in a regular pattern, e.g. in rows or in an array.

More specifically it is the ends, the through orifices of these channels or pores at each of the surfaces which are arranged in a regular pattern on the first main surface and/or second main surface (see FIGS. 1 and 13).

Advantageously, the inter-pore distance is of the order of magnitude of the width, preferably the inter-pore distance is equal to the width, e.g. the diameter, of the pores.

Advantageously, the inter-pore distance is from nm to 1000 nm, preferably 10 nm to 100 nm, more preferably 20 nm to 50 nm, better still 30 nm to 40 nm.

Advantageously, the electrically insulating metal or metalloid oxide is chosen from among alumina oxide, preferably porous anodic alumina oxide (AAO), and silica.

The compound comprising a crystalline fraction may be chosen from among ionic liquids that are crystalline or semi-crystalline (before confinement) at any temperature below 100° C., and in particular at ambient temperature.

In general ionic liquids may be defined as liquid salts comprising a cation and an anion. Ionic liquids are therefore generally composed of a bulk organic cation, imparting a positive charge thereto, with which an inorganic anion is associated imparting a negative charge thereto. In addition, ionic liquids, as their name indicates, are generally liquid in the temperature range of 0° C. to 200° C., in particular around ambient temperature and they are often called Room Temperature Ionic Liquids (RTILs).

Ionic liquids are of a wide diversity.

For example, the C⁺ cation of the ionic liquid may be chosen from among hydroxonium, oxonium, ammonium, amidinium, phosphonium, uronium, thiouronium, guanidinium, sulfonium, phospholium, phosphorolium, iodonium, carbonium cations; and from heterocyclic cations such as pyridinium, quinolinium, isoquinolinium, imidazolium, pyrazolium, imidazolinium, triazolium, pyridazinium, pyrimidinium, pyrrolidinium, thiazolium, oxazolium, pyrazinium, piperazinium, piperidinium, pyrrolium, pyrizinium, indolium, quinoxalinium, thiomorpholinium, morpholinium and indolinium; and the tautomer forms thereof.

The anion of the ionic liquid may be chosen from among the halides such as Cl—, BF₄⁻, B(CN)₄⁻CH₃BF₃⁻, CH₂CHBF₃⁻, CF₃BF₃⁻, m-CₙF₂ₙ₊₁BF₃⁻ where n is an integer such that 1≦n≦10, PF₆⁻, CF₃CO₂⁻, CF₃SO₃⁻, N(SO₂CF₃)₂⁻, N(COCF₃)(SOCF₃)⁻, N(CN)₂⁻, C(CN)₃⁻, SCN⁻, SeCN⁻, CuCl₂⁻ and AlCl₄⁻.

Examples of ionic liquids are given in document FR-A-2 935 547 to whose description reference can be made.

Or else the compound comprising a crystalline fraction may be chosen from among polymers that are semi-crystalline or crystalline polymers (before confinement) at any temperature below 100° C., and in particular at ambient temperature.

If the electrolyte comprises a liquid or amorphous compound, the liquid or amorphous compound of the electrolyte may be chosen from among liquid or amorphous polymers (before confinement).

The compounds of the electrolyte that are liquid or amorphous at a temperature below 100° C., e.g. at ambient temperature, are preferably chosen from among the polymers, notably oligomers, of POE and the derivatives thereof.

If the electrolyte comprises a polymer whether crystalline, semi-crystalline, liquid or amorphous, the electrolyte which may optionally also comprise a conductive salt is then generally called a polymer electrolyte or electrolyte polymer.

The polymer, before it is confined, also called a non-confined polymer, is often designated by the term <<bulk polymer>>.

By polymer in the meaning of the invention is meant homopolymers, and copolymers and oligomers as well.

Advantageously, the semi-crystalline or crystalline, or liquid or amorphous polymer is chosen from among polymers which allow good solvation of the ions of alkaline metals such as Li.

Advantageously, the semi-crystalline or crystalline or liquid or amorphous polymer is chosen from among the homopolymers and copolymers of ethylene oxide and the derivatives thereof.

The homopolymers and copolymers of ethylene oxide and their derivatives, semi-crystalline or crystalline, generally have a crystallinity of at least 10%.

Advantageously, the polymer has a molar mass of 100 kg/mol or less.

Advantageously, the polymer has a molar mass lower than its entanglement mass.

The entanglement mass is generally defined as the mass on and after which the dynamics of the polymer is located in a creeping regime.

The entanglement mass of PEO is 3600 g/mol.

Advantageously, the polymer is chosen from among polyethylene oxides having a molar mass of less than 3600 g/mol, preferably from 44 to 2000 g/mol.

Advantageously, the electrolyte may further comprise an ionic conductive salt.

Advantageously, the ionic conductive salt is a lithium salt.

Advantageously the lithium salt may be chosen for example among LiAsF₆, LiClO₄, LiBF₄, LiPF₆, LiBOB, LiODBF, LiR_{F}SO₃ for example LiCF₃SO₃, LiCH₃SO₃, LiN(R_{F}SO₂)₂ for example LiN(CF₃SO₂)₂(LiTFSI) or LiN(C₂F₅SO₂)₂ (LiBETI), LiC(R_{F}SO₂)₃ for example LiC(CF₃SO₂)₃ (LiTFSM), where R_{E} is chosen from among a fluorine atom and a perfluoroalkyl group comprising 1 to 8 carbon atoms, LiTFSI is the acronym for lithium bis(trifluoromethylsulfonyl)imide, LiBOB that of lithium bis(oxalato)borate, and LiBETI that of lithium bis(perfluoroethylsulfonyl)imide.

Advantageously, the concentration of ionic conductive salt when present in the electrolyte in particular in the polymer electrolyte, may range from 1 to 50% by mass relative to the mass of the electrolyte e.g. the polymer electrolyte.

Advantageously, the electrolyte is a polymer electrolyte which comprises a polyethylene oxide that is semi-crystalline before confinement and a lithium salt, preferably LiTFSI.

Advantageously, the ratio of the lithium atoms to the oxygen atoms of the ether groups of polyethylene glycol is equal to or less than 1:8, for example this ratio may be 1:8, 1:12 or 1:16.

Advantageously, the electrolyte such as a polymer electrolyte entirely fills the pores or channels.

It is to be noted that the electrolyte such as a polymer electrolyte is not in the form of particles, in particular of discrete nanoparticles, but indeed in the form of a continuous, compact mass filling each of the pores and in contact with the walls thereof.

Advantageously, the polymer electrolyte is confined within the pores by immersing the porous membrane consisting of an electrically insulating metal or metalloid oxide in excess molten or liquid polymer electrolyte, preferably in vacuo and under heat above the melting point of the electrolyte.

It can be said that the liquid polymer electrolyte enters into the porous structure simply by capillarity.

The mineral membrane with an electrolyte, for example with a polymer electrolyte according to the invention, has never been described in the prior art such as represented in particular by the above-cited documents.

The electrolyte membrane e.g. with a polymer electrolyte according to the invention does not have the defects of the electrolytes, e.g. of the polymer electrolytes, of the prior art and brings a solution to the problems raised by electrolytes for example polymer electrolytes of the prior art.

The mineral membrane with an electrolyte according to the invention has at least two essential characteristics, namely first the presence of pores of nanometric cross-section which confine an electrolyte e.g. a polymer electrolyte, and second the fact that these pores are through pores substantially oriented in the same direction, even in the same direction, namely the direction of the thickness of the membrane and all substantially parallel, even parallel.

The combination of these two characteristics imparts the membrane with an electrolyte, e.g. with a polymer electrolyte, according to the invention, with advantageous and surprising properties particularly regarding its ionic conductivity at ambient temperature.

It can be said that the membrane with an electrolyte e.g. with a polymer electrolyte, according to the invention, on account of its two essential characteristics, allows an improvement in the performance of electrolytes and in particular of polymer electrolytes at ambient temperature by means of joining, combining three effects, namely:

(i) nanoconfinement of the electrolyte e.g. of the polymer electrolyte, due to the nanometric size of the pores;

(ii) one-dimensional ionic conduction, due to the uniform orientation of the pores and to their relatively directional, even directional, nature;

(iii) transfer to the membrane of the stress of mechanical resistance of the electrolyte, making it possible to use liquid electrolytes or low molecular weight electrolytes, e.g. oligomers, and hence to obtain a significant improvement in the conductivity of the electrolyte.

Nanoconfinement, generally defined by a characteristic size of the membrane pores confining the electrolyte of 1000 nm or less, preferably of 100 nm or less e.g. 10-50 nm, in particular in the case of an electrolyte polymer allows lowering of the melting point of the polymer by a Gibbs-Thomson, so that melting of the polymer preferably occurs at ambient temperature.

More generally, the effect of nanoconfinement is to reduce, even fully eliminate the crystalline fraction that said compound comprises before incorporation thereof in the pores or channels of the membrane, thereby increasing conductivity.

It can be said that nanoconfinement leads to partial or total amorphization of the compound and to a system having greater mobility.

For a semi-crystalline polymer such as POE, nanoconfinement leads to partial amorphization and advantageously to lowering of the melting point of the polymer.

In the liquid state, above its melting point, the polymer is generally 10 to 100000 times less viscous than below its melting point.

The one-dimensional conduction in pores having low tortuosity means that the transport properties of the electrolytes from one electrode to the other are not affected in the membrane of the invention.

If the compound is already liquid or amorphous at a temperature below 100° C., and in particular at ambient temperature, it is this 1D one-directional aspect which predominates in relation to the nanoconfinement aspect.

If the electrolyte is an electrolyte which comprises at least one compound which comprises a crystalline fraction before being confined in the pores of the membrane, i.e. a compound such as a crystalline or semi-crystalline polymer for example a polyethylene oxide, the invention takes advantage of the Gibbs-Thomson effect. Said effect is never referred to, mentioned, suggested and above all researched in the prior art relating to mineral electrolyte membranes (mineral membranes with an electrolyte).

The Gibbs Thomson effect is only obtained when two conditions are combined, namely:

1) Confinement, generally nanometric, also called nanoconfinement;

2) The nanoconfined compound material must be crystalline or semi-crystalline.

When these two conditions are met, it is observed—and this is the case in the present invention—that the melting i.e. the changeover from crystal to liquid of the confined compound material occurs at a lower temperature than when this same compound material is a bulk, non-confined material.

Therefore, according to the invention, via nanometric confinement of an electrolyte which comprises at least one crystalline or semi-crystalline compound, a liquid electrolyte is obtained at a temperature at which it is usually solid and at which it therefore usually exhibits poor conductivity.

In addition, according to the invention, an additional gain in conductivity is obtained due to a second effect which is induced by the topology of the porous network of the membrane according to the invention.

Indeed, the fact that pores having <<1D>> orientation are used, limits any effect of tortuosity, any chicane and any <<labyrinthine>> geometry that would be most harmful for the transport of electrolytes over a long distance i.e. from one electrode to the other.

The combination of these two effects (<<Gibbs-Thomson>> and 1D transport), leading to an unexpected and major improvement in conductivity is neither mentioned nor suggested in the prior art.

Compared with the electrolytes and in particular the polymer electrolytes of the prior art, the advantages brought by the membrane of the invention essentially concern performance, safety and economic viability.

Regarding performance, the membrane of the invention has the advantages of an operating temperature generally in the region of ambient temperature, and near one-dimensional conduction.

Regarding safety, the membrane of the invention has the advantages of ensuring confinement of the electrolyte and of preventing dissemination of the electrolyte into the environment in the event of rupture of the battery—which is particularly advantageous with regard to liquid electrolytes—and of limiting the phenomenon of dendritic growth and hence risks of spontaneous combustion of the battery.

Regarding economic viability, the membrane of the invention has the advantage of allowing a reduction in the quantity of conductive salt used in the composition of the electrolyte, in particular lithium salt, leading to reduced cost of the electrolyte and of the battery in which it is contained. In addition, as specified above, since the phenomenon of dendritic growth and related risks are limited, the electrolyte membrane e.g. with a polymer electrolyte according to the invention may have its applications extended to portable and/or consumer electronics.

The invention further concerns an electrochemical device comprising an electrolyte membrane, for example with a polymer electrolyte such as described above.

In particular, the invention concerns a lithium storage battery comprising an electrolyte membrane e.g. a solid polymer membrane such as described above, a positive electrode and a negative electrode (FIG. 12).

This lithium storage battery may be a Li-metal battery in which the negative electrode made of lithium metal, or else this lithium battery may be a Li-ion battery.

Said device has all the advantages inherently related to the use in such devices of the electrolyte membrane e.g. with a polymer electrolyte according to the invention.

Finally, the invention relates to the use of a mineral membrane in which:
the membrane is a porous membrane made of an electrically insulating metal or metalloid oxide comprising a first main surface (1) and a second main surface (2) separated by a thickness (3);
through pores or channels (4), open at their both ends (5, 6), having a width of 1000 nm or less, preferably 100 nm or less, oriented in the direction of the thickness (3) of the membrane and all substantially parallel over the entire thickness (3) of the membrane, connect the first main surface (1) and the second main surface (2);

to obtain a Gibbs-Thomson effect in an electrolyte confined in the pores (4) of the membrane, and optionally one-dimensional (1D) transport of said electrolyte from the first main surface (1) to the second main surface (2) or from the second main surface (2) to the first main surface (1);

and in which said electrolyte comprises at least one compound comprising a fraction that is crystalline at any temperature below 100° C., before being confined within the pores of the membrane.

Such electrolytes have already been described in the foregoing.

The invention will now be described more precisely in the following description that is non-limiting and given by way of illustration with reference to the appended drawings in which:

### BRIEF DESCRIPTION OF THE DRAWINGS

FIG. 1 is a schematic illustration of a membrane made of porous anodic alumina (aluminium oxide) (AAO).

FIG. 2 is a scanning electron microscope image (SEM) of the surface of a membrane made of porous anodic alumina (aluminium oxide) (AAO).

The scale indicated in FIG. 2 represents 100 nm.

FIG. 3 is a 3D SEM view of a fragment of membrane made of porous anodic alumina (aluminium oxide).

The scale indicated in FIG. 3 is 1 μm.

FIG. 4 gives photographs showing the changes undergone by the surface of an aluminium sheet, plate, during anodization. The pictures in FIGS. 4A, 4B and 4C were taken at increasing anodization times.

FIG. 5A is a schematic vertical cross sectional view showing the structure of the anodized aluminium sheet, plate of FIG. 4B, with a layer of aluminium trapped between two films of alumina, and FIG. 5B is another photograph of the anodized aluminium sheet, plate of FIG. 4B.

FIG. 6 gives SEM images showing the adjustment of the final diameter of the pores for a 15V_{—}−5° C._{—}20 h_H₂SO₄ membrane. FIG. 6A shows an image of the initial membrane, and Dₚ is about 20 nm. FIG. 6B is an image of the membrane after an attack, etching, time of 10 minutes and Dₚ is about 23 nm. FIG. 6C is an image of the membrane after an attack time of 30 minutes and Dₚ is about 30 nm. FIG. 6D is an image of the membrane after an attack time of 45 minutes and its surface is deteriorated. The scale in FIGS. 6A to 6D is 100 nm.

FIG. 7A is a graph which gives I(cm⁻¹) as a function of Q(Å⁻¹) measured by Small Angle Neutron Scattering (SANS) for a 15V_{—}−5° C._{—}20 h_H₂SO₄ membrane subjected to attack by a 5 weight % solution of phosphoric acid for varying times namely 0 minute (curve A), 10 minutes (curve B), 30 minutes (curve C), and 45 minutes (curve D).

FIG. 7B is a graph which shows analytical calculation of the variation I(Q) as a function of Dₚ (Rₚ (for 3 values of Rₚ, namely 140 nm (curve C), 120 nm (curve B) and 100 nm (curve A), with Dᵢₙₜ constant using the model of oriented cylinders.

FIG. 7C is a graph showing the distance Dₚ (squares) or the distance Dᵢₙₜ (triangles) expressed in nm, as a function of attack, etching time (minutes).

FIG. 8A is a schema showing the principle of elimination of residual aluminium.

FIG. 8B is a photograph showing a membrane after the step to eliminate residual aluminium.

FIGS. 9A and 9B are SEM images of the upper side (as shown in FIG. 8A), and lower side (as shown in FIG. 8A), respectively, of a 20V_{—}−10° C._{—}20 h_H₂SO₄ membrane.

The scale indicated in FIGS. 9A and 9B is 100 nm.

FIG. 10 is a schema showing the principle of the opening of the barrier layer.

FIG. 11 gives SEM images of the back face of a 15V_{—}−5° C._{—}20 h_H₂SO₄ membrane immersed in a 5 wt. % solution of phosphoric acid, illustrating the opening of the barrier layer at 20 minutes (A), 30 minutes (B), 45 minutes (C) and 1 hour (D).

The scale in FIGS. 11A, 11B and 11D is 100 nm, and the scale in FIG. 11C is 200 nm.

FIG. 12 is a schema of a storage battery comprising the electrolyte membrane, in particular the membrane with a solid polymer electrolyte according to the invention.

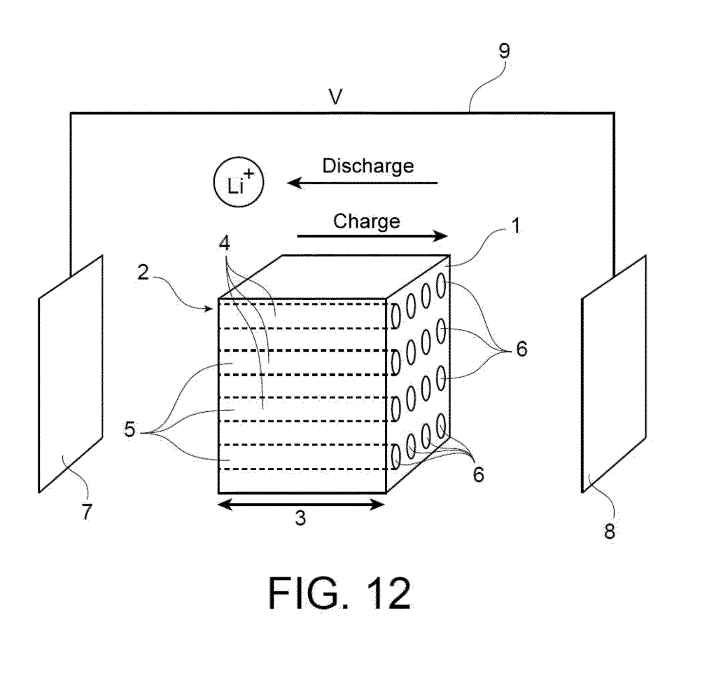

The Li⁺ ions are only mentioned in FIG. 12 as an example.

### DETAILED DESCRIPTION OF PARTICULAR EMBODIMENTS

This description refers more particularly to an embodiment in which the mineral electrolyte membrane is a membrane with polymer electrolyte, in particular the membrane with polymer electrolyte of a lithium storage battery, accumulator but evidently the following description may optionally be easily extended to any mineral electrolyte membrane able to be used in any electrochemical device or system, irrespective of the liquid, amorphous, semi-crystalline or crystalline electrolyte.

In addition, the following description is rather more given for practical reasons related to the method for preparing the membrane of the invention, but it also contains teachings which concern the membrane prepared using this method.

A description is first given below of the preparation of the polymer electrolyte.

The polymer of the polymer electrolyte is generally a semi-crystalline polymer which must be able to act as solvent for the cation of the conductive salt such as lithium.

The semi-crystalline polymer of the electrolyte may therefore be chosen from among all those polymers comprising chemical groups showing sufficient affinity for alkaline ions, in particular so that they are able to dissolve salts of alkaline metals.

Preferably, the semi-crystalline polymer is chosen from among the homopolymers and copolymers of ethylene oxide.

More preferably, the polymer of the electrolyte is a straight-chain homopolymer of ethylene oxide meeting the formula [CH₂—CH₂—O]ₙ, where the value of n is from 1 to 3000, e.g. about 300.

In current polymer electrolytes, for reasons related to the mechanical strength of the electrolytes, polymers of high molecular weight are generally used, for example having a weight average molar mass M_{w} higher than 100 kg.mol⁻¹.

Electrolyte polymers based on PEO may therefore be prepared from polymers of high molar mass, anging from 10⁵ to several million grams per mole, which impart good mechanical properties to the electrolyte polymers.

By mechanical properties is generally meant herein shear, stretch and compression strength.

However, in a membrane such as the one that is the subject of the invention which is based on the principle of confinement of the electrolyte and in particular of the polymer electrolyte in the pores of a rigid oxide membrane, the mechanical properties can be ensured essentially by this membrane made of porous oxide and it is therefore no longer necessary to use polymers of very high molar mass.

The polymers used in the invention may therefore have a lower molar mass than the polymer electrolytes used up until now, for example they may have molar masses of 100 kg.mol⁻¹ or less.

In addition, it has been shown that low molar masses improve conduction properties, and it is therefore also possible to optimize ionic conduction by using such polymers, e.g. PEOs, of lower molar mass.

A molar mass range below the entanglement mass of the polymer is favourable for accessing a regimen which can be qualified as <<rapid polymer dynamics>> which promotes the conduction of ions and in particular of Li⁺ ions.

The entanglement mass is a known parameter which can easily be determined by the man skilled in the art for each polymer.

The entanglement mass is generally the molar mass on and after which the dynamics of the polymer become reptational.

For example, the entanglement mass of PEO (homopolymer) is 3600 g/mol.

The conductive salt of the polymer electrolyte is generally a salt of an alkaline metal such as a lithium salt. By lithium salt is meant a salt comprising at least the Li⁺ cation.

However, other salts could optionally be used in relation to the desired application

The lithium salt can be chosen for example from among LiAsF₆, LiClO₄, LiBF₄, LiPF₆, LiBOB, LiODBF, LiR_{F}SO₃ e.g. LiCF₃SO₃, LiCH₃SO₃, LiN(R_{F}SO₂)₂ e.g. LiN(CF₃SO₂)₂ (LiTFSI) or LiN(C₂F₅SO₂)₂ (LiBETI), LiC(R_{E}SO₂)₃ e.g. LiC(CF₃SO₂)₃ (LiTFSM), in which R_{E} is chosen from among a fluorine atom and a perfluoroalkyl group having 1 to 8 carbon atoms, LiTFSI is the acronym for lithium bis(trifluoromethylsulfonyl)imide, LiBOB that of lithium bis(oxalato)borate, and LiBETI that of lithium bis(perfluoroethylsulfonyl)imide.

Among these lithium salts, LiTFSI is often used since it is one of among those exhibiting the best conductivity in PEO and its derivatives.

The concentration of conductive salt e.g. of conductive lithium salt is generally 1 to 50% by weight relative to the total weight of the electrolyte e.g. of the polymer electrolyte.

For a PEO polymer, maximum conductivity is obtained with concentrations corresponding to a proportion of 1 atom of lithium per 8 atoms of oxygen (O/Li=8).

A reference electrolyte polymer is therefore P(OE)₈LiTFSI with M_{w} POE=100 kg.mol⁻¹ which is one of the electrolyte polymers subject of the most research.

However, it has been evidenced that by confining these semi-crystalline polymers in accordance with the invention, it is possible to lower and even eliminate the proportion of crystalline fraction whilst obtaining good ionic conductivity.

On this account, conductivity under confinement can be optimized by choosing electrolyte polymers with lower salt concentrations, for example concentrations of conductive salt, e.g. conductive lithium salt.

For PEO polymers it is therefore possible to use concentrations corresponding to a proportion of 1 lithium atom per 12 oxygen atoms, even 16 oxygen atoms.

Examples of such polymers are for example P(OE)₁₂LiTFSI and P(OE)₁₆LiTFSI.

The use of electrolyte polymers having a lower concentration of conductive salt e.g. lithium salt has the major advantage of reducing the cost of the electrolyte, and hence the cost of the device such as a battery or storage battery, accumulator in which it is contained.

To prepare the polymer electrolyte, it is necessary to dissolve the conductive salt such as a lithium salt in a polymer matrix.

The dissolution kinetics of the salt in the polymer matrix is an important parameter to take into consideration when determining the preparation protocol of the polymer electrolyte intended to be confined in the pores of the membrane according to the invention.

Yet these kinetics are extremely slow, and without any special protocol thermodynamic equilibrium may take several years to be reached.

A protocol which allows these kinetics to be accelerated and the electrolyte polymer to be prepared has now been well established and is known to the man skilled in the art, and has already been described in the literature.

The protocol described below more particularly concerns the preparation of a polymer electrolyte containing PEO and a lithium salt such as LiTFSI, but it may optionally be easily adapted by the man skilled in the art to the preparation of any polymer electrolyte irrespective of the semi-crystalline polymer and conductive salt constituting these polymer electrolytes.

The PEO and lithium salt are dissolved in a common solvent. After a fairly long homogenization time, for example 1 to 12 hours, the solvent is removed by evaporation with in vacuo pumping.

The solvents most used for this preparation are acetonitrile or methanol.

Solvent-free electrolyte polymers are then obtained.

A further important aspect is that the preparation of an electrolyte polymer in some cases, depending on the type of polymer and/or conductive salt, may require special precautions.

For example, since lithium salts are extremely hygroscopic, it is necessary to dry the starting product in vacuo beforehand and to perform mixing of the polymer and salt in an inert atmosphere, e.g. argon and/or helium.

The polymer such as PEO is sometimes purified, for example by re-crystallization or filtration, to remove stabilizers and other impurities.

The preparation protocol for the polymer electrolyte developed by the inventors ensures that the reagents or the final electrolyte polymer are not at any time in contact with air and moisture throughout the preparation.

A glove-box was used for the preparation of the electrolyte polymer but arrangements were made to reduce the number of steps requiring the glove-box.

In general, the lithium salts are stored in the glove-box in which H₂O and O₂ levels are controlled.

The preparation of the electrolyte polymer is conducted in a hermetically closed reactor to ensure a controlled atmosphere. This reactor consists of two parts which can be separated to facilitate collection of the sample.

The PEO, a hygroscopic compound, is initially weighed outside the glove-box, giving consideration to the weight of water contained therein. It is dried in vacuo for example at 70° C. for, for example, about ten hours in the reactor.

Before dissolving the PEO in anhydrous acetonitrile, helium is caused to circulate inside the reactor.

The LiTFSI lithium salt, available for example from Aldrich, is weighed in stoichiometric composition and is placed in a hermetic flask inside the glove-box.

The following steps are conducted under a laboratory hood.

The lithium salt is dissolved in acetonitrile before being placed in the reactor using a syringe.

The reactor is then isolated throughout the entire homogenization phase, for example for a time of 48 hours at a temperature of 50° C. for example.

The solvent is then evaporated off in vacuo for example at 70° C., for example for 70 hours.

Acetonitrile is a toxic solvent, it is important to place a solvent trap in the assembly before the vacuum pump for recovery of the solvent during the drying step of the sample.

After the drying phase, the reactor is opened in the glove-box. The collected sample remains stored therein.

Simultaneously with, prior to or after the above-described preparation of the porous polymer electrolyte, a porous membrane made of an electrically insulating metal or metalloid oxide is prepared.

As confinement material, the invention preferably uses membranes made of porous alumina (Anodic Aluminium Oxide or AAO): these are ceramic membranes (very good electric insulators) having sides of a few centimetres for example 0.1 to 100 and a thickness of a few hundred microns for example 1 to 800 μm or 1 to 500 μm.

The porosity consists of cylindrical pores of nanometric diameter, but the originality of this material is related to the fact that these pores are oriented and are all substantially parallel, even parallel, over the entire thickness of the membrane with an anisotropic ratio of the channels i.e. a length/diameter ratio of about 300 μm/30 nm, i.e. 10⁴.

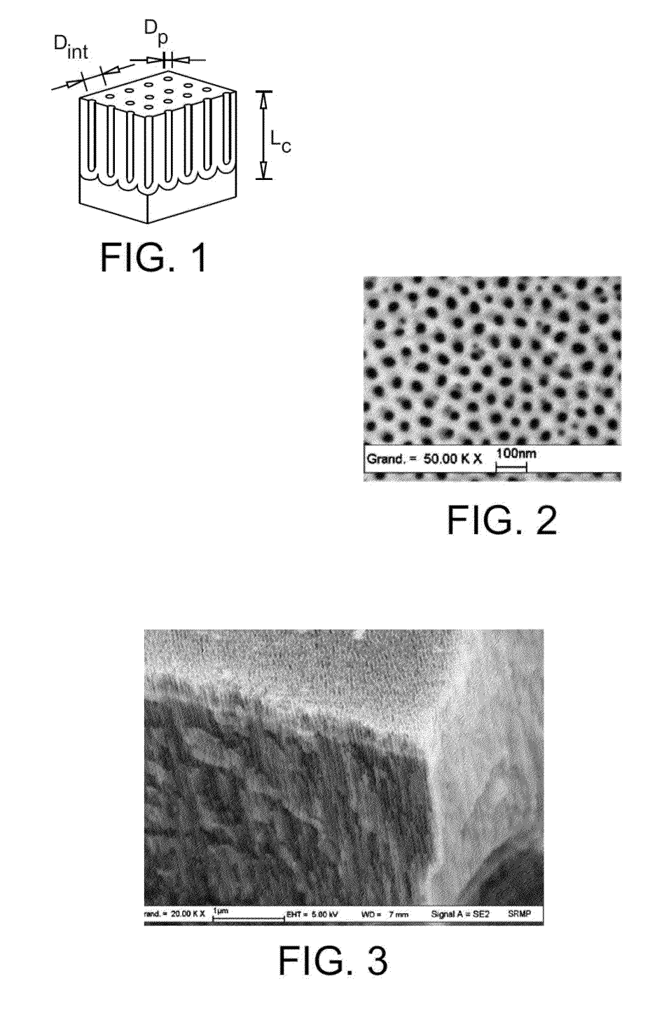

FIG. 1 schematically illustrates a porous AAO membrane. The topology of the membrane (this applying to any membrane and not only to alumina membranes) is defined by the diameter of the pores (Dₚ), the inter-pore distance (Dᵢₙₜ) and the length of the channels (L_{C}).

FIG. 2 is an image taken under scanning electron microscope (SEM) of the surface of an AAO membrane.

FIG. 3 is a 3D scanning electron microscope (SEM) image of a fragment of an AAO membrane. The cylindrical pores can be seen starting from the surface then passing through the body of the membrane.

The synthesis parameters used to prepare the membranes allow full control over the topology of the membrane, in particular the diameter of the pores and their length.

It is possible to obtain thick membranes of several hundred μm, for example 1 μm to 800 μm, that are easy to handle.

A series of post-synthesis treatments ensures the opening of the pores on each side of the membrane.

The confinement of the polymer is simply ensured by immersion of the matrix in excess polymer in vacuo and under heat: at O-order it can be said that the liquid polymer enters inside the porous structure by mere capillarity.

In the remainder hereof a description is given of the preparation, synthesis of a membrane made of porous alumina, more precisely made of porous anodic aluminium oxide.

The man skilled in the art will easily be able to determine protocols allowing other porous membranes to be prepared made of other electrically insulating metal or metalloid oxides.

To prepare a porous membrane made of alumina, a substrate made of aluminium is used generally consisting of sheets 3 cm by 5 cm and having a thickness of 2 mm.

The aluminium is initially degreased using acetone for example before being electro-polished, in other words before undergoing electrochemical polishing.

It is optionally possible, before electro-polishing, to conduct re-crystallization treatment of the aluminium, e.g. at 500° C. in vacuo for 12 hours.

Electro-polishing of the aluminium is then carried out.

Electro-polishing can be performed in any electro-polishing device known to the man skilled in the art, and the electro-polishing conditions can easily be adapted by the man skilled in the art.

In the electro-polishing assembly more particularly used, the electrode connected to the negative pole of the generator consists of a gold wire. The electrolyte used for electro-polishing is a mixture of 60% perchloric acid (HClO₄) with ethanol (C₂H₅OH) in a volume ratio of 25:75.

A potential of 40V is applied for about ten seconds under vigorous agitation.

A mirror effect is rapidly observed on the surface of the aluminium.

The samples are then rinsed in distilled water.

After the electro-polishing step of the aluminium, the electro-polished aluminium is anodized.

Similar to electro-polishing, anodization can be performed in any anodization device known to the man skilled in the art, and the anodization conditions can easily be adapted by the man skilled in the art.

The anodization assembly more particularly used is similar to the one described for electro-chemical polishing.

The cathode is a platinum electrode and the electro-polished aluminium is placed in anode position. A thermo-regulated bath provides control over the temperature at between −10° C. and 25° C.

The electrolytes used are sulfuric acid (H₂SO₄, vol. %), oxalic acid (C₂O₄H₂ at 0.3 mol.L⁻¹) and phosphoric acid (H₃PO₄ 5 wt. %). In this assembly, an ammeter was added to monitor the trend in intensity throughout anodization.

As an example, the protocol initially described by Masuda et al. (H. Masuda and M. Satoh, Japan Journal of Applied Physics, 1996, 35, L 126-129) to obtain a porous alumina membrane with an hexagonal array, was adapted as follows:

A first anodization is performed for 3 minutes in an oxalic medium at 40V and at ambient temperature, followed by dissolution of the oxide layer for 2 hours 30 minutes in a mixture of chromic acid (H₂CrO₄ 1.8 wt. %) and phosphoric acid (6 wt. %) at 60° C.

A second anodization is then performed for 20 minutes in an oxalic medium at 40V and at ambient temperature.

The porous matrix is then carefully rinsed in distilled water and dried in vacuo at 80° C. for a few hours.

The nomenclature adopted to identify the samples has the following form: [anodization voltage] [temperature] [anodization time] [electrolyte]. Within this nomenclature, the reference sample is denoted: 40V_{—}25° C._{—}20 min_C₂O₄H₂.

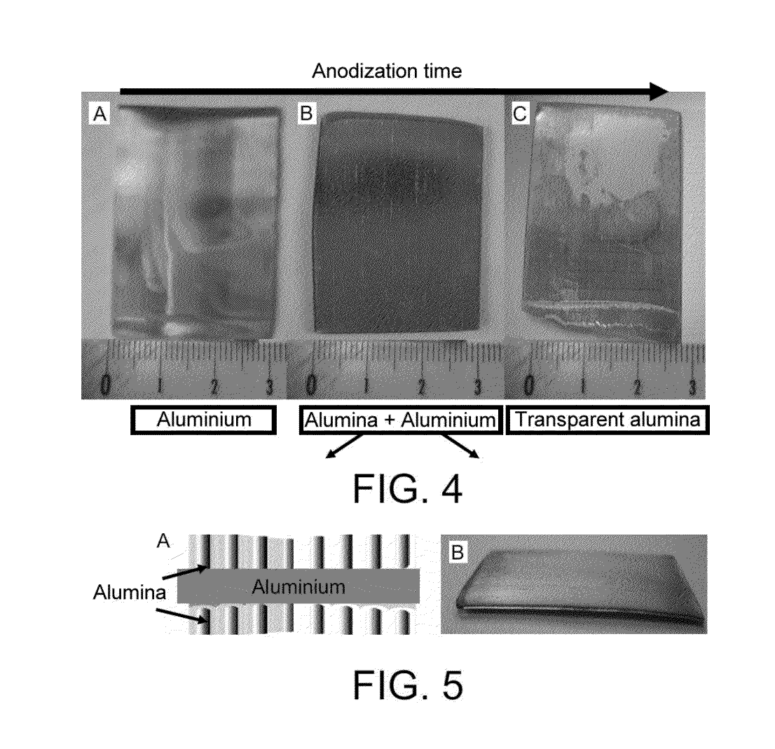

The changes undergone by an aluminium sheet, plate, during anodization are shown in FIG. 4 (FIGS. 4A to 4B) and in FIG. 5 (FIGS. 5A and 5B). The initial aluminium in the form of a sheet, plate, 3 cm by 5 cm (a) (FIG. 4A) is anodized on its two sides. Depending on anodization time, residual aluminium may be trapped between the two alumina films (b) (FIG. 4B and FIGS. 5A and 5B). If anodization is continued until there is no longer any aluminium, the final sheet consists essentially of the two alumina films and is near-transparent (c) (FIG. 4C).

The porous matrix obtained after anodization has the same geometry as the initial aluminium and is therefore easy to handle.

After anodization, several treatments may be conducted on the membranes made of porous anodic alumina (Anodic Aluminium oxide or AAO) thus obtained. These treatments are generally called post-anodization treatments.

One or more post-treatments are generally used depending on the desired application for the porous alumina membranes.

This or these post-treatments may be of chemical type to adjust the final size of the pores, as described in the document by Y. ZHAO et al., Materials Letters, 2005, 59, 40-43; in the document by H. MASUDA and M. SATOH, Japan Journal of Applied Physics, 1996, 35, L 126-129; and in the document by T. T. XY, R. D. PINER and R. S. RUOFF, Langmuir, 2003, 19, 1443-1445; or to open the porous membrane, or of thermal type to homogenize the chemical composition.

Such post-treatments are well known to the man skilled in this field of the art and will therefore not all be described in detail.

A description will only be given here of chemical treatments to open and adjust the diameter of the pores and to open the membrane.

The adjustment of the final diameter of the pores is obtained by chemical treatment, for example using a solution of phosphoric acid (H₃PO₄ 5 wt. %).

The porous alumina membrane is immersed in the acid solution at ambient temperature for a determined time, for example 30 minutes.

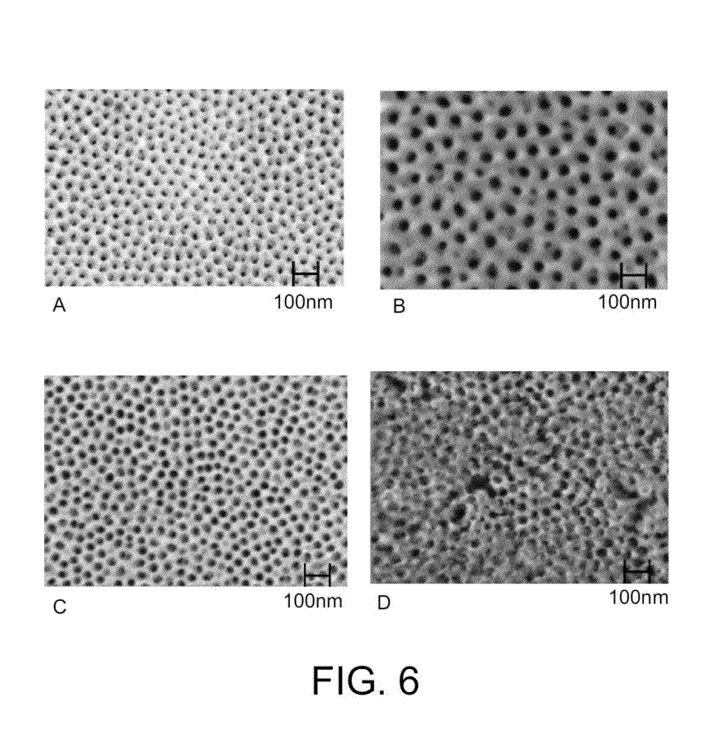

The chemical attack dissolves the walls of the pores causing a gradual increase in the diameter of the pores as shown in FIG. 6 (FIGS. 6A, 6B, 6C, 6D). Nonetheless, extended chemical attack, for 45 minutes, deteriorates the membrane as can be seen in FIG. 6D.

The advantage of this technique is that it is possible to adjust the diameter of the pores as a function of attack, etching time.

It is recalled that the morphology of membranes made of porous anodic alumina (AAO) is fully defined by 4 parameters, namely: the inter-pore distance or Dᵢₙₜ, the diameter of a pore Dₚ, the depth of the channels L_{c} and the thickness of the barrier layer L_{b} of residual aluminium (see FIG. 1)

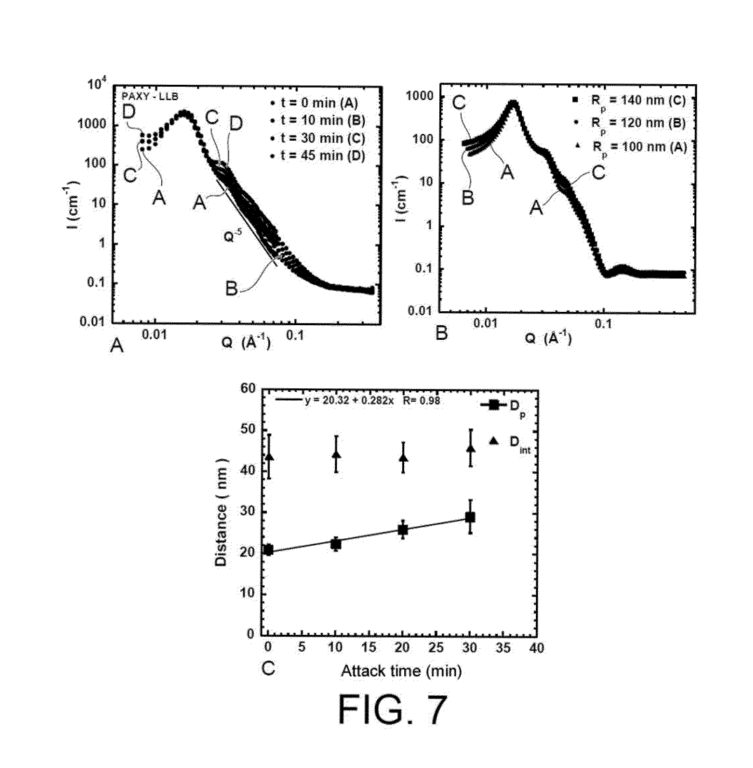

Dₚ varies linearly with attack, etching time, whereas Dᵢₙₜ remains constant as shown in FIG. 7C.

Measurements by SANS, given in FIG. 7A, confirm SEM results: the structure peak, and hence Dᵢₙₜ, remains unchanged whereas the intensity of the second peak is greater the more the attack time is increased. The intensity of the second peak is greater the more Dₚ increases.

Nevertheless, observation under SEM is essential to complete SANS measurement which does not allow detection that the membrane attacked for 45 minutes has deteriorated on the surface.

Another treatment which can be conducted on the membrane made of porous anodic alumina (AAO) is the opening of this porous membrane.

One of the major advantages of AAOs is that it is possible to obtain a porous system open on both sides of the membrane. To open the porous membrane, the usual technique is initially to remove the residual aluminium then to open the barrier layer as described in the document by T. T. XY, R. D. PINER and R. S. RUOFF, Langmuir, 2003, 19, 1443-1445, already cited.

Another method has been suggested to simplify opening of the pores in a single step, the principle being to electrically remove the membrane from the residual aluminium.

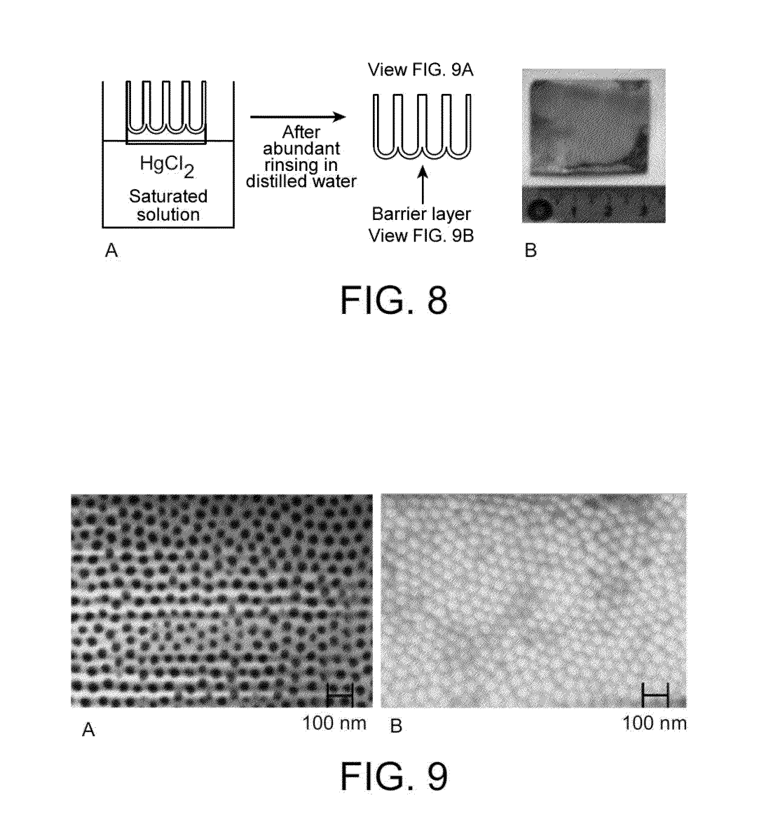

A description is given below of the usual technique for opening the membrane in which, in a first step, the residual aluminium is removed, then in a second step the barrier layer is opened (see FIG. 8).

In the first step, the residual aluminium is removed by a chemical oxidation-reduction attack, for example using a saturated solution of mercury dichloride (HgCl₂).

A mixture containing copper dichloride (CuCl₂) can also be used as mentioned in the above-cited document by T. T. XY.

The principle of this treatment is to immerse the membrane in the saturated solution, and to wait until there is no more aluminium in contact with the membrane.

In the protocol described for anodization, it was seen that the initial aluminium is anodized on its two sides (see FIGS. 4B, 5A, 5B).

In reality, anodization occurs on the four sides of the aluminium, trapping the residual aluminium behind the four aluminas sides. Removal of the aluminium is then difficult to perform and the sheet breaks at numerous points.

If the final membrane is near-transparent (see FIG. 4C), the residual aluminium is inaccessible since it is trapped in the core of the membrane.

This protocol was therefore modified so as only to anodize the aluminium on one side to facilitate removal of the residual aluminium.

The aluminium is coated on one of its sides with a protective resin from the first anodization.

This protective layer is renewed before the 2^{nd} anodization. The resin is then removed just before immersing the membrane in the HgCl₂-saturated solution (FIG. 8A).

Once the aluminium has been removed, the membrane is rinsed abundantly in distilled water.

At the end of this step, the membrane is fully transparent (see FIG. 8B).

In particular, the back of the membrane which was located at the alumina/aluminium interface then reveals the barrier layer which consists of the bottom of the pores.

In FIGS. 9A and 9B, which are SEM images of a 20V_{—}−10° C._{—}20 h_H₂SO₄ membrane, it can be seen that the upper side of the membrane reveals the porous structure opening into either side (FIG. 9A), whilst the lower side reveals the barrier layer and more particularly the back of the pores. This side is blocked by a thin barrier layer (FIG. 9B).

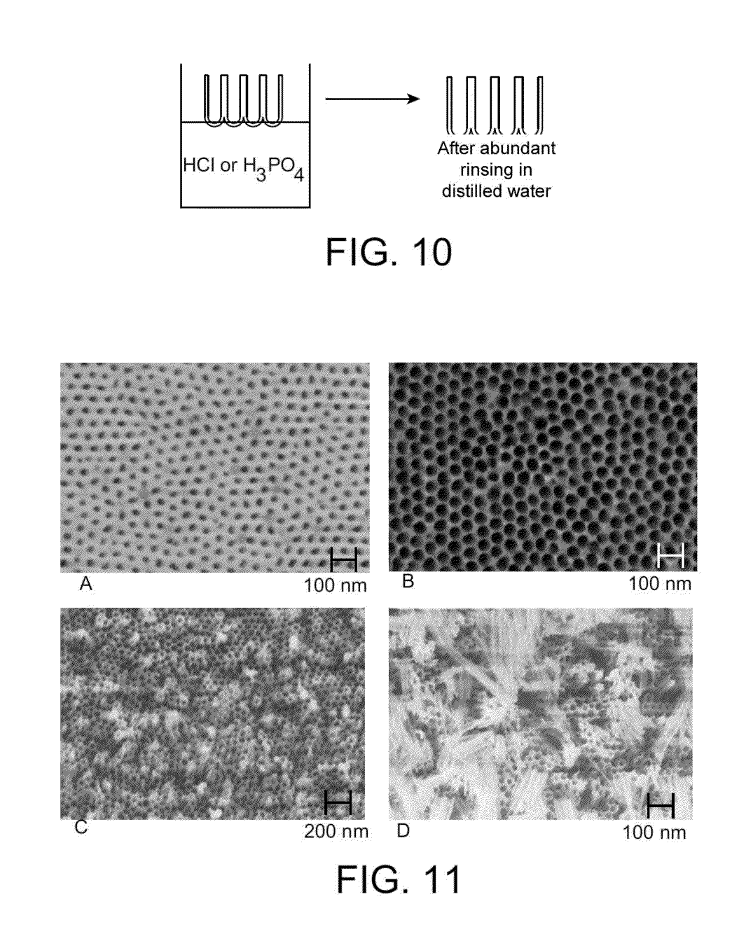

In the following step, the barrier layer is opened by immersing the membrane, for example in a solution of phosphoric acid (H₃PO₄ 5 wt. %)). This step is similar to the one during which the diameter of the pores is adjusted (see FIG. 10).

The objective is to control the time of attack so as not to damage the porous structure.

The treatment time must be adapted in relation to the preparation conditions of the membrane insofar as the thickness of the barrier layer is dependent on the preparation voltage.

For 20V_{—}−10° C._{—}20 h_H₂SO₄ membranes, in accordance with the above-indicated nomenclature, the optimum attack time is 30 minutes (see FIG. 11 and in particular FIG. 11B).

The opening of the barrier layer is illustrated in FIG. 11 which gives SEM images of the back surface of a 20V_{—}−10° C._{—}20 h_H₂SO₄ membrane immersed in a 5 weight % solution of phosphoric acid for 20 minutes (FIG. 11A), for 30 minutes (FIG. 11B) (the barrier layer is opened), for 45 minutes (FIG. 11C), and for one hour (FIG. 11D) (the porous structure is damaged). A picture of the membrane before chemical attack is shown in FIG. 9B.

As indicated above, conductivity under confinement can be optimised by choosing electrolyte polymers having lower salt concentrations, such as P(OE)₁₂LiTFSI and P(OE)₁₆LiTFSI.

The electrolyte membrane, e.g. with polymer electrolyte according to the invention such as described above, can be used in any electrochemical system using a polymer electrolyte (FIG. 12).

This electrochemical system may particularly be a rechargeable electrochemical storage battery such as a lithium storage battery, accumulator or battery which, in addition to the electrolyte membrane e.g. with polymer electrolyte such as defined above, comprises a positive electrode; a negative electrode; generally current collectors (7,8), generally made of copper for the negative electrode, or made of aluminium for the positive electrode, which allow the circulation of electrons, and hence electronic conduction in the external circuit (9); and generally a separator allowing contact and hence a short circuit to be prevented between the electrodes, these separators possibly being microporous polymer membranes.

The negative electrode may consist of lithium metal as electrochemically active material in the case of lithium-metal storage batteries; otherwise the negative electrode may comprise intercalation materials as electrochemically active material such as graphite carbon (C_{gr}) or lithiated titanium oxide (Li₄Ti₅O₁₂) in the case of storage batteries based on lithium-ion technology.

The positive electrode, as electrochemically active material, generally comprises lithium intercalation materials such as lamellar oxides of lithiated transition metals, olivines or lithiated iron phosphates (LiFePO₄) or spinels (e.g. the spinel LiNi_{0,5}Mn_{1,5}O₄).

More specifically, if they do not consist of lithium metal, the electrodes comprise a binder which is generally an organic polymer, an electrochemically active positive or negative electrode material, optionally one or more electron conducting additives and a current collector.

In the positive electrode, the electrochemically active material may be chosen from among the compounds already cited above in the present description, and from among LiCoO₂; compounds derived from LiCoO₂ obtained by substitution preferably by Al, Ti, Mg, Ni and Mn, for example LiAlₓNi_{y}Co_{(1-x-y)}O₂ where x<0.5 and y<1, LiNiₓMnₓCo₁₋₂ₓO₂; LiMn₂O₄; LiNiO₂; compounds derived from LiMn₂O₄ obtained by substitution preferably by Al, Ni and Co; LiMnO₂; compounds derived from LiMnO₂ obtained by substitution preferably by Al, Ni, Co, Fe, Cr and Cu, for example LiNi_{0,5}O₂; the olivines LiFePO₄, Li₂FeSiO₄, LiMnPO₄, LiCoPO₄; the iron phosphates and sulfates whether hydrated or not; LiFe₂(PO₄)₃; the vanadyl phosphates and sulfates whether hydrated or not, for example VOSO₄ and LiₓVOPO₄; nH₂O (0<x<3, 0<n<2); Li₍₁₊ₓ₎V₃O_{8, 0}<x<4; LiₓV₂O₅, nH₂O, where 0<x<3 and 0<n<2; and mixtures thereof.

In the negative electrode, the electrochemically active material may be chosen from among the compounds already cited above in the present description; and from among carbon compounds such as natural or synthetic graphite and disordered carbons; lithium alloys of Li_{X}M type with M=Sn, Sb, Si; the LiₓCu₆Sn₅ compounds with 0<x<13; iron borates; simple oxides with reversible decomposition, for example CoO, Co₂O₃, Fe₂O₃; pnictides, for example Li_{(3-x-y)}Co_{y}N, Li_{(3-x-y)}Fe_{y}N, LiₓMnP₄, LiₓFeP₂; LiₓFeSb₂; and the insertion oxides such as titanates, for example TiO₂, Li₄Ti₅O₁₂, LiₓNiP₂, LiₓNiP₃, MoO₃ and WO₃ and mixtures thereof, or any material known to the man skilled in this technical field.

The optional electron conducting additive may be chosen from among metallic particles such as Ag particles, graphite, carbon black, carbon fibres, carbon nanowires, carbon nanotubes and electron conducting polymers, and mixtures thereof.

The current collectors are generally made of copper for the negative electrode, or made of aluminium for the positive electrode.

The storage batteries which comprise the electrolyte membrane, for example with a polymer electrolyte of the invention, can notably be used for propelling motor vehicles and for powering portable electronic equipment such as computers, telephones and portable game consoles.

1.-34. (canceled)

35. Mineral electrolyte membrane wherein:
the membrane is a porous membrane made of an electrically insulating metal or metalloid oxide comprising a first main surface (1) and a second main surface (2) separated by a thickness (3);
through pores or channels (4) open at their both ends (5,6), having a width of 1000 nm or less, oriented in the direction of the thickness (3) of the membrane and all substantially parallel over the entire thickness (3) of the membrane, connect the first main surface (1) and the second main surface (2); and
an electrolyte is confined in the pores (4) of the membrane; a Gibbs-Thomson effect and optionally a one-dimensional (1D) transport of said electrolyte from the first main surface (1) to the second main surface (2) or from the second main surface (2) to the first main surface (1) being obtained in said electrolyte.

36. The membrane according to claim 35 wherein said electrolyte comprises at least one compound comprising a fraction that is crystalline at any temperature below 100° C., before being confined in the pores of the membrane.

37. The membrane according to claim 35 wherein said electrolyte comprises at least one compound that is liquid or amorphous below 100° C.

38. The membrane according to claim 35 wherein the pores or channels have an orientation mosaicity which does not exceed 10%.

39. The membrane according to claim 36 wherein said crystalline fraction represents at least 1% by weight of the at least one compound.

40. The membrane according claim 35 wherein the first and the second main surfaces are planar and parallel, the membrane is a planar membrane and the pores or channels are substantially aligned, or aligned, perpendicular to said surface.

41. The membrane according to claim 35 wherein the pores or channels have a width of 10 nm to 1000 nm.

42. The membrane according to claim 35 wherein the pores or channels are cylindrical pores.

43. The membrane according to claim 42 wherein said cylindrical pores have a circular or substantially circular cross-section or an elliptical cross-section.

44. The membrane according to claim 35 wherein the pores or channels have a length of 100 nm to 900 μm.

45. The membrane according to claim 35 wherein the channels or pores are arranged in a regular pattern.

46. The membrane according to claim 35 wherein the inter-pore distance is of the order of magnitude of the width, e.g. of the diameter of the pores.

47. The membrane according to claim 46 wherein the inter-pore distance is 10 nm to 1000 nm.

48. The membrane according to claim 35 wherein the electrically insulating metal or metalloid oxide is chosen from among alumina and silica.

49. The membrane according to claim 36 wherein the compound comprising a crystalline fraction is chosen from among crystalline or semi-crystalline ionic liquids.

50. The membrane according to claim 36 wherein the compound comprising a crystalline fraction is chosen from among semi-crystalline or crystalline polymers.

51. The membrane according to claim 37 wherein the liquid or amorphous compound is chosen from among liquid or amorphous polymers.

52. The membrane according to claim 50 wherein the semi-crystalline or crystalline polymer is chosen from among polymers allowing good solvation of the ions of alkaline metals.

53. The membrane according to claim 50 wherein the semi-crystalline or crystalline polymer is chosen from among the homopolymers and copolymers of ethylene oxide, and the derivatives thereof.

54. The membrane according to claim 51 wherein the molar mass of the polymer is equal to or less than 100 kg/mol.

55. The membrane according to claim 51 wherein the molar mass of the polymer is lower than its entanglement mass.

56. The membrane according to claim 55 wherein the polymer is chosen from among polyethylene oxides having a molecular weight of less than 3600 g/mol.

57. The membrane according to claim 36 wherein the electrolyte further comprises an ionic conductive salt.

58. The membrane according to claim 57 wherein the ionic conductive salt is a lithium salt chosen from among LiAsF₆, LiClO₄, LiBF₄, LiPF₆, LiBOB, LiR_{F}SO₃, LiCH₃SO₃, LiN(R_{F}SO₂)₂, and LiC(R_{F}SO₂)₃, where R_{F} is chosen from among a fluorine atom and a perfluoroalkyl group comprising 1 to 8 carbon atoms, and LiBOB is lithium bis(oxalato)borate.

59. The membrane according to claim 57, wherein the concentration of ionic conductive salt in the electrolyte is 1 to 50% by weight relative to the weight of the electrolyte.

60. The membrane according to claim 58 wherein the electrolyte comprises a polyethylene oxide that is semi-crystalline before being confined and a lithium salt.

61. The membrane according to claim 60 wherein the ratio of lithium atoms to oxygen atoms of the ether groups of polyethylene glycol is equal to or less than 1:8.

62. The membrane according to claim 35 wherein the electrolyte fully fills the pores or channels.

63. The solid polymer electrolyte membrane according to claim 50 wherein the polymer electrolyte is confined in the pores by immersing the porous membrane made of electrically insulating metal or metalloid oxide into excess molten or liquid polymer electrolyte, preferably in vacuo and under heat.

64. An electrochemical device comprising an electrolyte membrane according to claim 35.

65. A lithium storage battery comprising an electrolyte membrane according to claim 35, a positive electrode and a negative electrode.

66. The storage battery according to claim 65 which is a lithium-metal storage battery.

67. The storage battery according to claim 65 which is a lithium-ion storage battery.

68. The membrane according to claim 51 wherein the liquid or amorphous polymer is chosen from among polymers allowing good solvation of the ions of alkaline metals.

69. The membrane according to claim 51 wherein the liquid or amorphous polymer is chosen from among the homopolymers and copolymers of ethylene oxide, and the derivatives thereof.

70. The membrane according to claim 57 wherein the ionic conductive salt is a lithium salt chosen from among LiCF₃SO₃, LiN(CF₃SO₂)₂ (LiTFSI), LiN(C₂F₅SO₂)₂ (LiBETI), and LiC(CF₃SO₂)₃ (LiTFSM: tri(perfluoromethane-sulfonyl)lithium methylide), where LiTFSI is the acronym for lithium bis(trifluoromethylsulfonyl)imide, and LiBETI that of lithium bis(perfluoroethylsulfonyl)imide.
